(19) United States
(12) Patent Application Publication
(10) Pub. No.: US 2009/0126472 A1
(43) Pub. Date: May 21, 2009

(54) COMBUSTION PRESSURE SENSOR FOR INTERNAL COMBUSTION ENGINE

(75) Inventors: Yoshinobu Hirose, Inabe-gun (JP); Takehiro Watarai, Kuwana-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/273,716

(22) Filed: Nov. 19, 2008

(30) Foreign Application Priority Data
Nov. 19, 2007 (JP) 2007-298850
Oct. 15, 2008 (JP) 2008-266090

(51) Int. Cl. G01M 15/04

(52) U.S. Cl. 73/114.18

(57) ABSTRACT

A combustion pressure sensor has a cylindrical housing having a fixing functional member fixed to an engines head, and a sealing functional member disposed on the inner side of the fixing member, a transmission member disposed on the inner side of the sealing member through an opening to face a combustion chamber and to be movable along the axial direction, a detecting unit disposed between the sealing member and the transmission member to detect a combustion pressure in the combustion chamber in response to the movement of the transmission member, and a seal member for shielding the opening from the combustion chamber. The members are connected with each other at a connection area such that extension and contraction in the axial direction in each of the functional members is independent of the other one.

### CROSS-REFERENCE TO RELATED APPLICATION

This application is based upon and claims the benefit of priority of the prior Japanese Patent Application 2007-298850 filed on Nov. 19, 2007, and the prior Japanese Patent Application 2008-266090 filed on Oct. 15, 2008, so that the contents of which are incorporated herein by reference.

### BACKGROUND OF THE INVENTION

1. Field of the Invention

The present invention relates to a combustion pressure sensor which detects the combustion pressure of a combustion gas in a combustion chamber of an internal combustion engine such as a diesel engine.

2. Description of Related Art

The present invention relates to a combustion pressure sensor which detects a combustion pressure of a combustion gas in a combustion chamber of an internal combustion engine such as a diesel engine.

3. Description of Related Art

An internal combustion engine such as a diesel engine is provided with a combustion pressure sensor to detect a combustion pressure of a combustion gas in each of combustion chambers of the engine. This sensor is, for example, disclosed in Published Japanese Patent First Publication No. 2005-90554. FIG. 1 is a longitudinal sectional view of a combustion pressure sensor 9 disclosed in this Publication.

As shown in FIG. 1, the combustion pressure sensor 9 has a transmission member 91 for receiving a combustion pressure of a combustion gas in a combustion chamber, a housing 92 for holding the member 91 so as to be movable along an axial direction, and a pressure sensor 93 for detecting the pressure received in the member 91. When the member 91 receives a combustion pressure of the combustion gas, the member 91 is moved relative to the housing 92 along the axial direction to transmit this pressure to the sensor 93 disposed on the proximal side of the sensor 9. Therefore, the sensor 93 detects the combustion pressure. The sensor 9 further has an O-ring 94 and an elastic film 95 disposed so as to close an inner space between the member 91 and the housing 92 to the combustion gas of the combustion chamber. Each of the O-ring 94 and the elastic film 95 prevents the combustion gas set at a high temperature from penetrating into the inner space. The film 95 is welded and fixed to the member 91 and the housing 92 to shield the gas from the inner space.

To attach the sensor 9 to the internal combustion engine, a fixing portion 97 of the housing 92 is screwed and fastened to a female thread of the engine while a taper portion 96 of the housing 92 placed on the distal side of the sensor 9 is brought into contact with a protruding portion of the engine. Therefore, when the sensor 9 is attached to the engine, a portion 98 between the portions 96 and 97 is slightly shortened in the axial direction. Because the member 91 is fixed to the portion 98 of the housing 92 through the film 95, the member 91 is undesirably moved with the housing 92 in the axial direction in response to this shortening of the portion 98.

Therefore, in response to this movement of the member 91 caused by the shortening of the portion 98, the member 91 always transmits stress caused by the movement to the sensor 93 even when the member 91 receives no combustion pressure. This stress caused by the movement unnecessarily generates a change in the output of the sensor 93. As a result, an initial value of the sensor 9 is changed, and the precision in the pressure detection of the sensor 9 is undesirably lowered.

To adequately use the sensor 9 for the engine control, it is required to correct the output value of the sensor 3 by using another sensor. This correcting work increases the manufacturing cost of the sensor 9. Further, it sometimes becomes difficult to control the engine by using the sensor 9.

Further, each time the member 91 receives the combustion pressure, a load is applied to the film 95, an attaching surface between the member 91 and the film 95 and an attaching surface between the housing 92 and the film 95. Therefore, the film 95 is easily damaged or broken, so that the sensor 9 is inferior in durability. To improve the durability, it is required to heighten the strength of the film 95 and the strength at the attaching surfaces.

To prevent the sensor from being broken by the load applied to the film and the attaching surfaces, another combustion pressure sensor is, for example, disclosed in Published Japanese Patent First Publication No. 2006-84468. FIG. 2 is a longitudinal sectional view of a combustion pressure sensor 90 disclosed in this Publication No. 2006-84468.

As shown in FIG. 2, the combustion pressure sensor 90 has an elastic film 99 formed in a bellows shape. This film 99 can extend and contract in the axial direction. Each time the member 91 receiving a combustion pressure is moved relative to the housing 92, the film 99 extends or contracts in the axial direction to absorb the load applied to the film 99. Further, when the housing 92 is shortened in response to the attaching work for attaching the housing 92 to the engine so as to move the film 99 in the axial direction, the film 99 extends or contracts in the axial direction to prevent the member 91 from being moved in response to the shortening of the housing 92.

However, the film 99 formed in the bellows shape increases the manufacturing cost of the sensor 90, so that it is difficult to manufacture the sensor 90 at a low cost.

### SUMMARY OF THE INVENTION

An object of the present invention is to provide, with due consideration to the drawbacks of the conventional, a combustion pressure sensor which is manufactured at a low cost, is superior in durability and detects a combustion pressure with high precision.

According to an aspect of this invention, the object is achieved by the provision of a combustion pressure sensor comprising a housing substantially having a cylindrical shape, a transmission member disposed on the inner side of the housing in the radial direction of the sensor through an opening to be movable along the axial direction of the sensor in response to a combustion pressure of a combustion gas, a detecting unit for detecting the combustion pressure in response to the movement of the transmission member, and a seal member for shielding the opening between the housing and the transmission member from a combustion chamber of an internal combustion engine. The housing has a fixing functional member and a sealing functional member disposed on the inner side of the fixing functional member. The fixing functional member has a fixing portion fixed to the engine. The fixing functional member and the sealing functional member are connected with each other at a connection area such that extension and contraction in the axial direction in the sealing functional member is independent of the fixing functional member. The transmission member is disposed on the inner side of the sealing functional member so as to face the sealing functional member through the opening and to be exposed to a combustion gas of the combustion chamber on the first side in the axial direction. The detecting unit is disposed between the sealing functional member of the housing and the transmission member on the second side in the axial direction opposite to the first side so as to face the opening. The seal member is attached to the sealing functional member of the housing and the transmission member on the first side so as to shield the opening from the combustion chamber.

With this structure of the sensor, each time the transmission member is moved along the axial direction of the sensor in response to the combustion pressure in the combustion chamber, the detecting unit detects the combustion pressure in response to the movement of the transmission member. Therefore, the sensor can detect the combustion pressure.

The seal member shields the opening from the combust ion chamber. Therefore, the seal member prevents the combustion gas having a high temperature from penetrating into the opening between the transmission member and the sealing functional member. That is, the seal member can reduce a heat load which is received in the detecting unit from the combustion gas through the opening. Accordingly, the combustion pressure sensor can be superior in durability.

Further, when the fixing portion of the fixing functional member of the housing is fixed to the engine, the fixing functional member receives stress from the engine so as to compress or shorten the fixing functional member in the axial direction. However, the functional members are connected with each other at the connection area such that extension and contraction of the sealing functional member in the axial direction is independent of the fixing functional member. That is, even when the fixing functional member receives the stress from the engine, the sealing functional member receives no stress from the fixing functional member through the connection area. Therefore, the positional relationship between the sealing functional member and the transmission member can be reliably maintained. As a result, even when the fixing functional member receives stress from the engine, the transmission member applies no load to the detecting unit.

Accordingly, because no stress is applied to the transmission member when the sensor is attached to the engine, the detecting unit can detect the combustion pressure with high precision. That is, the sensor can detect the combustion pressure with high precision. Further, because it is not required to calibrate the output of the detecting unit by using another sensor, the combustion pressure sensor can be manufactured at a low cost.

Moreover, because the positional relationship between the sealing functional member and the transmission member is maintained when the sensor is attached to the engine, stress applied to the seal member can be considerably reduced. Therefore, it is not required to heighten the strength of the seal member, the attaching strength between the seal member and the sealing functional member, or the attaching strength between the seal member and the transmission member. Further, the seal member can be reliably attached to the sealing functional member and the transmission member while maintaining an adequate sealing performance.

Accordingly, the combustion pressure sensor superior in durability can be easily manufactured at low cost.

Preferably, the fixing functional member have stress receiving portion extending from an end of the fixing portion toward the first side, and the connection area be placed at the same position in the axial direction as the end of the fixing portion or be placed on the second side of the end of the fixing portion.

With this structure, the sealing functional member is disposed to be separated from the stress receiving portion, so that the sealing functional member does not directly receive the stress from the stress receiving portion. Further, the fixing portion fixed to the engine receives the stress from the stress receiving portion and releases the stress to the engine. Therefore, the stress is not transmitted to the sealing functional member through the fixing portion.

Accordingly, the positional relationship between the sealing functional member and the transmission member can be reliably maintained, so that the sensor can detect the combustion pressure with high precision.

### BRIEF DESCRIPTION OF THE DRAWINGS

FIG. 1 is a longitudinal sectional view of a combustion pressure sensor disclosed in Published Japanese Patent First Publication No. 2005-90954;

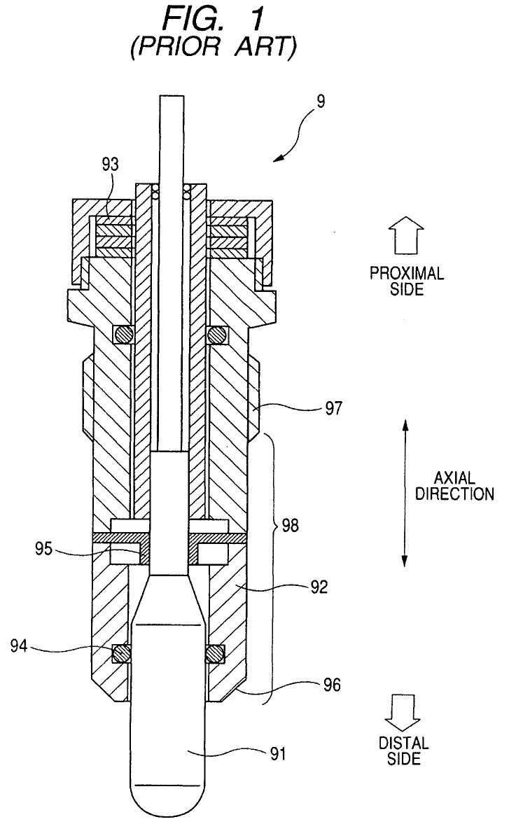

FIG. 2 is a longitudinal sectional view of a combustion pressure sensor disclosed in Published Japanese Patent First Publication No. 2006-84468;

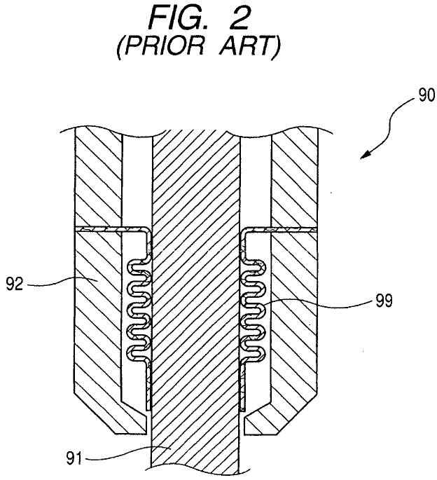

FIG. 3 is a longitudinal sectional view of a combustion pressure sensor according to the first embodiment of the present invention;

FIG. 4 is a sectional view taken substantially along line A-A of FIG. 3;

FIG. 5 is a view showing the relationship between a spring constant ratio K1/K2 and an absolute value of hysteresis error;

FIG. 6 is a longitudinal sectional view of a combustion pressure sensor according to the second embodiment of the present invention;

FIG. 7 is a sectional view taken substantially along line B-B of FIG. 6;

FIG. 8 is a longitudinal sectional view of a combustion pressure sensor according to the third embodiment of the present invention;

FIG. 9 is a longitudinal sectional view of a combustion pressure sensor according to the fourth embodiment of the present invention; and

FIG. 10 is a longitudinal sectional view of a combustion pressure sensor according to the fifth embodiment of the present invention.

### DETAILED DESCRIPTION OF THE PREFERRED EMBODIMENTS

Embodiments of the present invention will now be described with reference to the accompanying drawings, in which like reference numerals indicate like parts, members or elements throughout the specification unless otherwise indicated.

### Embodiment 1

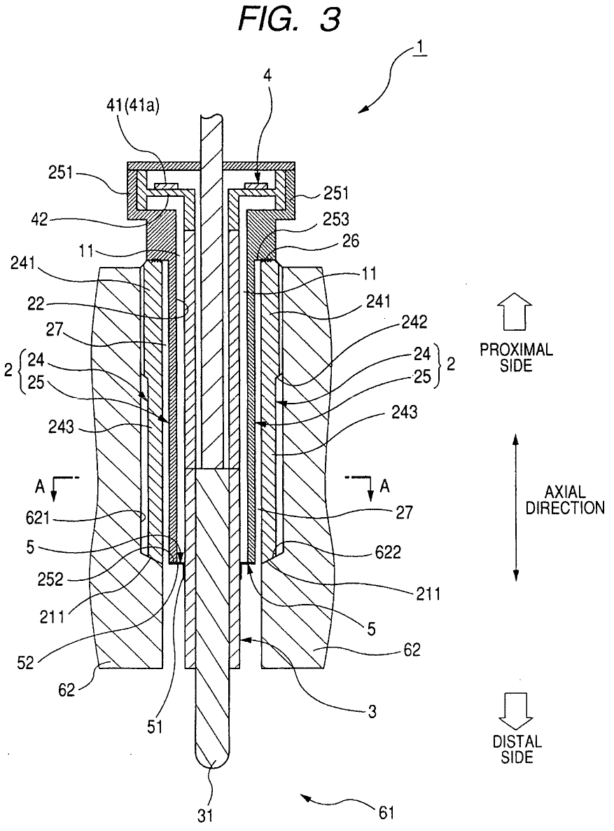

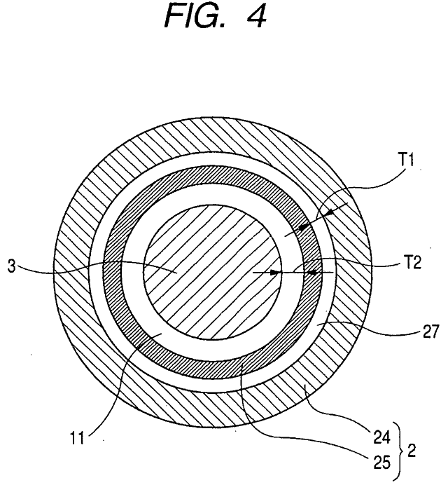

FIG. 3 is a longitudinal sectional view of a combustion pressure sensor according to the first embodiment, while FIG. 4 is a sectional view taken substantially along line A-A of FIG. 3.

An internal combustion engine such as a diesel engine has a plurality of engine heads. As shown in FIG. 3 and FIG. 4, a combustion pressure sensor 1 approximately formed in a columnar shape is inserted into an attaching hole 621 of an engine head 62 of the engine such that a portion of the sensor 1 on the distal side (or first side) in the axial direction of the sensor 1 is protruded into a combustion chamber 61 of the engine. Another portion of the sensor 1 on the proximal side (or second side) in the axial direction is fixedly attached to the engine head 62 to detect a combustion pressure of a combustion gas in the combustion chamber 61 of the engine.

The sensor 1 has a housing 2 approximately formed in a cylindrical shape so as to have an axial hole 22 in the center thereof, a transmission member 3 disposed in the hole 22 of the housing 2 to be movable in an axial direction of the sensor 1 in response to the combustion pressure in the chamber 61 and to transmit the movement as the combustion pressure, a load detecting unit 4 disposed between the housing 2 and the transmission member 3 on the proximal side of the sensor 1 to detect a change in a load acting on the unit 4 in response to the movement of the transmission member and to detect the combustion pressure from the detected change, and a seal member 5 attached to the housing 2 and the transmission member 3 on the distal aide of the sensor 1 to shield an opening 11 formed between the housing 2 and the transmission member 3 from the chamber 61. The opening 11 is formed in the hole 22 between the housing 2 and the transmission member 3, and the seal member 5 closes the opening 11 to the combustion gas of the chamber 61. The seal member 5 is, for example, formed of a flexible film.

The transmission member 3 has a pressure receiving portion 31 protruded from the housing 2 into the chamber 61 so as to be exposed to the combustion gas. The portion 31 is movable along the axial direction of the sensor 1 in response to the combustion pressure.

The housing 2 has a fixing functional member 24 approximately formed in a cylindrical shape and a sealing functional member 25 approximately formed in a cylindrical shape on the inner side of the functional member 24 in the radial direction of the sensor 1. The members 24 and 25 are separately formed. Each of the functional members 24 and 25 is disposed independent of the other one. The members 24 and 25 are coaxially placed. The members 24 and 25 are attached to each other, at a connection area 26 such that extension and contraction of each of the functional members 24 and 25 in the axial direction is independent of the other functional member. In other words, extension and contraction of the sealing functional member 25 in the axial direction is independent of the fixing functional member 24, so that the sealing functional member 25 receives no stress from the fixing functional member 24 through the connection area 26 even when the functional member 24 receives stress in the axial direction. The connection area 26 is placed at a proximal end of the functional member 24 on the proximal side. The members 24 and 25 are, for example, fixed to each other at the connection area 26 by welding or the like.

The fixing functional member 24 has a fixing portion 241 and a compression portion (or a stress receiving portion) 243 disposed along the axial direction. The portion 241 has a male thread on its outer circumferential surface and a top end 242 on the distal side. The portion 243 extends from the top end 242 of the portion 241 toward the distal side. The fixing portion 241 is screwed and fastened to the engine head 62 to fix the sensor 1 to the engine head 62. The compression portion 243 has a chamfer 211 being in contact with a taper portion 622 of the head 62 on the distal side of the portion 243. The fixing portion 241 is screwed and fastened to the engine head 62 while the chamfer 211 is in contact with the taper portion 622 of the head 62. Therefore, the compression portion 243 receives stress such as a compressive force directed in the axial direction from the head 62. The connection area 26 is placed on the proximal side of the fixing portion 241 so as to locate the portion 241 between the area 26 and the compression portion 243. Although the fixing portion 241 receives the compressive force from the portion 243, because the fixing portion 241 is fixed to the head 62, the compressive force is not transmitted to the sealing functional member 25 through the connection area 26. Therefore, although the sealing functional member 25 is attached to the fixing functional member 24, the sealing functional member 25 receives no stress from the fixing functional member 24.

The sealing functional member 25 has a mounting portion 251 on the proximal side, and the load detecting unit 4 is fixedly mounted on the mounting portion 251. The member 2S faces the transmission member 3 through the opening 11. The member 25 has a top end 252 on the distal side, and the seal member 5 is attached to the end 252 and an outer circumferential surface of the portion 31 to shield the opening 11 from the chamber 61.

A clearance 27 communicating with the chamber 61 is formed between the functional members 24 and 25, and the clearance 27 reaches a proximal end 253 of the sealing functional member 25. The proximal end 253 is placed approximately at the same position in the axial direction as the contact area 26. The clearance 27 is closed at the proximal end 253. As shown in FIG. 4, the clearance 27 has a width T1 in the radial direction, and the width T1 of the clearance 27 is constant along the axial direction. Further, the opening 11 has a width T2 in the radial direction, and the width T2 of the opening 11 is constant along the axial direction. The width T1 of the clearance 27 is set to be smaller than the width T2 of the opening 11. The width T1 of the clearance 27 is set at a value ranging from 5 to 10 μm.

The reason that the relation T1<T2 is satisfied is as follows, when the transmission member 3 and the sealing functional member 25 mechanically interfere with each other, the functional member 25 has an adverse influence on the sliding movement of the transmission member 3 along the axial direction. As a result, an error will occur in the detection of the combustion pressure. To prevent the interference between the transmission member 3 and the functional member 25, it is need to set the width T2 of the opening 11 at a sufficiently large value. Further, when the fixing functional member 24 is fixed to the engine head 62, the compression portion 243 being in contact with the taper portion 622 of the head 62 receives a compressive force along the axial direction. Therefore, the functional member 24 is sometimes bent toward the inner side so as to approach the functional member 25. To prevent the functional members 24 and 25 from mechanically interfering with each other or to prevent the bent member 24 from pushing the functional member 2S, it is adequate to form the clearance 27 between the functional members 24 and 25. In contrast, when the width T1 of the clearance 27 is excessively large, a volume of the combustion gas entering into the clearance 27 is extraordinarily increased, so that the load detecting unit 4 excessively receives the heat load caused by the heat of the combustion gas entering into the clearance 27. In this case, an error will occur in the detection of the combustion pressure. To adequately reduce the heat load received in the unit 4, the width T1 of the clearance 27 should be small. For the above-described reasons, it is preferable that the width T1 of the clearance 27 be smaller than the width T2 of the opening 11.

The seal member 5 has a tubular portion 51 and a brim portion 52. The tubular portion 51 is attached to an outer circumferential surface of the transmission member 3 so as to surround the transmission member 3 along the circumferential direction of the sensor 1. The brim portion 52 extends from one end of the portion 51 toward the outer side in the radial direction and is attached to the top end 252 of the sealing functional member 25 to close or shield the opening 11 to or from the combustion chamber 61.

The load detecting unit 4 has both a strain generating portion 42 for generating strain or distortion in response to the displacement of the transmission member 3 and a strain gauge 41 having a plurality of detecting elements 41a for detecting the strain of the portion 42. The strain generating portion 42 is attached to both the mounting portion 251 of the sealing functional member 25 and the proximal end of the transmission member 3 so as to bridge a space between the functional member 25 and the transmission member 3. Therefore, when the transmission member 3 is moved or slid relative to the functional member 25 of the housing 2 in the axial direction in response to the combustion pressure of the combustion gas, the portion 42 is distorted to generate strain. The degree of this strain depends on the displacement of the transmission member 3 in the axial direction. In response to the strain generated in the portion 42, the electric resistance of the portion 42 between each pair of detecting elements 41a is changed. The strain gauge 41 measures the strain of the portion 42 from these changes to detect the combustion pressure of the combustion gas. In this embodiment, the strain gauge 41 is used for the unit 4. However, another device such as a piezo-electric device or the like may be used for the unit 4.

In an internal space of the pressure receiving portion 31 of the transmission member 3, a glow plug (not shown) is disposed to raise the temperature of air accumulated in the chamber 61. The glow plug has both a heat generating coil (or a heating member) and an electric current transmitting line (or a conducting member) such as a lead line. An electric current is supplied to the coil through the transmitting line, and the coil generates heat. Therefore, because the mixture of fuel and air can have a high temperature in the chamber 61, the mixture can be easily burned.

Next, an operation of the sensor 1 is now described.

When the combustion pressure of the combustion gas is applied to the pressure receiving portion 31 of the transmission member 3, the member 3 is moved or shifted to be displaced in the axial direction. The strain generating portion 42 of the load detecting unit 4 receives a displacement of the transmission member 3 in the axial direction. In response to this displacement, the portion 42 is distorted so as to generate strain. The strain gauge 41 of the unit 4 measures this strain to detect the combustion pressure. Therefore, the sensor 1 can detect the combustion pressure of the combustion gas.

During the operation of the sensor 1, the combustion pressure of the combustion gas is also applied to a seal section, composed of the seal member 5 and the sealing functional member 25 serially arranged along the axial direction. In this embodiment, the housing 2 is divided into the fixing functional member 24 and the sealing functional member 25, so that the hardness or rigidity of the housing 2 in the axial direction is lowered. In this case, each of the members 5 and 25 is slightly displaced in the axial direction in response to the combustion pressure, and the strain generating portion 42 is distorted due to the displacement of the seal section in the axial direction. The strain gauge 41 measures the strain of the portion 42 caused by the displacement of the seal section as well as the displacement of the transmission member 3. Especially, the displacement of the seal member 5 is apt to be larger than that of the sealing functional member 25, so that the strain gauge 41 reliably measures the strain of the portion 42 caused by the displacement of the seal member 5. As a result, there is a probability that the combustion pressure detected in the sensor 1 is fluctuated due to the displacement of the seal section so as to induce the sensor 1 not to correctly detect the combustion pressure.

To reduce the adverse influence of the displacement of the seal section on the detection of the combustion pressure, it is effective to reduce the displacement of the seal section. Further, it is effective that the displacement of the seal section is set to be sufficiently smaller than the displacement of the transmission member 3.

In this embodiment, to reduce the displacement of the seal section, the elastic deformation of the seal member 5 and the sealing functional member 25 in the axial direction is appropriately set. When the combustion pressure is applied to the members 5 and 25, the members 5 and 25 are elastically deformed in the axial direction so as to reduce the displacement of the member 5 and the displacement of the member 25. More specifically, materials of the members 5 and 25 are selected so as to be elastically deformed within an allowable range of the combustion pressure. Further, a spring constant (or spring modulus) K1 of the sealing functional member 25 is set to be equal to or higher than a spring constant K2 of the seal member 5. That is, the ratio K1/K2 is equal to or higher than 1 (K1/K2≧1). The spring constant K of a member is expressed by an equation: K=ΔF/ΔX (ΔF denotes a change of the force applied to the member, and ΔX denotes a deformation of the member).

In this case, because the spring constant K2 of the seal member 5 is smaller than the spring constant K1 of the sealing functional member 25, the deformation of the seal member 5 is larger than the deformation of the sealing functional member 25. Therefore, the displacement of the seal member 5 can be set to be smaller than the displacement of the sealing functional member 25, and the influence of the displacement of the seal member 5 on the displacement of the seal section can be reduced. That is, the displacement of the seal section can be set to be sufficiently smaller than the displacement of the transmission member 3.

Preferably, the ratio K1/K2 be set to be equal to or higher than 1.5 (K1/K2≧1.5). In this case, the deformation of the seal member 5 is further larger than the deformation of the sealing functional member 25. Therefore, the displacement of the seal member 5 can be further reliably set to be smaller than the displacement of the sealing functional member 25, and the influence of the displacement of the seal member 5 on the displacement of the seal section can be reduced. That is, the displacement of the seal section can be reliably set to be sufficiently smaller than the displacement of the transmission member 3.

To obtain the displacement of the seal section which is smaller than the displacement of the transmission member 3, it is preferable that a spring constant K3 of the seal section be set to be larger than a spring constant K4 of the transmission member 3. That is, the ratio K3/K4 is equal to or higher than 1 (K3/K4≧1). The spring constant K3 of the seal section is expressed by an equation; K3=K1·K2/(K1+K2).

In this case, the deformation of the seal section is larger than the deformation of the transmission member 3. Therefore, the displacement of the seal section can be further reliably set to be smaller than the displacement of the transmission member 3.

The inventors of this application actually examined the relationship between the spring constant ratio K1/K2 and the detection precision of the combustion pressure. In this examination, a plurality of sensors set at respective spring constant ratios K1/K2 are prepared as samples. Then, each sample measures the combustion pressure of a combustion gas experimentally prepared. This combustion pressure is known by the inventors and is controlled to be changed with time. During the measurement, hysteresis occurs in the combustion pressure detected by the sample. That is, when the combustion pressure set at a predetermined value is measured, the first measured result obtained while lowering the combustion pressure to the predetermined value differs from the second measured result obtained while heightening the combustion pressure to the predetermined value. A hysteresis error is calculated from a ratio of the difference between the first and second measured results to the first or second measured result.

When one sample has a large error due to hysteresis error, the adverse influence of the displacement of the seal section on the detection of the combustion pressure is large in the sample. Therefore, the sample cannot detect the combustion pressure with high precision. In contrast, when one sample obtains the hysteresis error having a low absolute value, the adverse influence of the displacement of the seal section is low in the sample. Therefore, the sample can detect the combustion pressure with high precision.

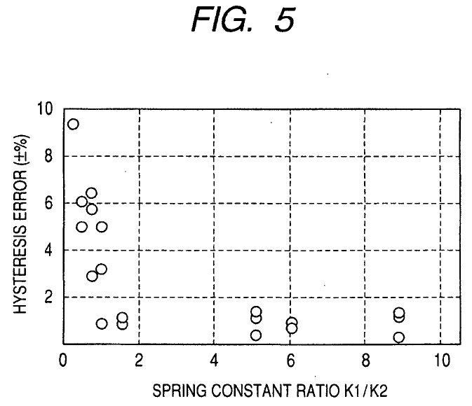

FIG. 5 is a view showing the relationship between the spring constant ratio K1/K2 and the absolute value of the hysteresis error (%) in each of the samples.

As shown in FIG. 5, the absolute values of the hysteresis error in the samples set at the ratios K1/K2 lower than 1 are high in a wide range from 3% to 7%. Therefore, these samples cannot detect the combustion pressure with high precision, and the combustion pressure detected is fluctuated. In contrast, the absolute values of the hysteresis error in the samples set at the ratios K1/K2 equal to or higher than 1 are low in a narrow range lower than 5%. Therefore, the samples set at the ratios K1/K2 equal to or higher than 1 can detect the combustion pressure with high precision. Accordingly, it will be realised that the sensor 1 set at the ratio K1/K2 equal to or higher than 1 can detect the combustion pressure with high precision.

Further, the absolute values of the hysteresis error in the samples set at the ratio K1/K2 equal to or higher than 1.5 are stable in a low range. Therefore, the samples set at the ratios K1/K2 equal to or higher than 1.5 can stably detect the combustion pressure with high precision. Accordingly, it will be realized that the sensor 1 set at the ratio K1/K2 equal to or higher than 1.5 can reliably and stably detect the combustion pressure with high precision.

Next, effects obtained in the sensor 1 will be described below.

During the operation of the sensor 1, the seal member 5 shields the opening 11 between the sealing functional member 25 of the housing 2 and the transmission member 3 from the combustion chamber 61. Therefore, the seal member 5 prevents the combustion gas from penetrating into the opening 11. Assuming that the combustion gas having a high temperature penetrates into the opening 11, the functional member 25 is heated by the heat of the combustion gas, and the load detecting unit 4 receives a heat load from the combustion gas of the opening 11 through the functional member 25. However, in this embodiment, because the seal member 5 suppresses the temperature increase of the functional member 25, the heat load applied to the unit 4 can be reduced. Accordingly, the sensor 1 can be superior in durability and can detect the combustion pressure with high precision.

Further, the housing 2 is divided into the fixing functional member 24 and the sealing functional member 25. When the sensor 1 is attached to the engine head 62, the fixing portion 241 of the functional member 24 is fixed to the engine head 62 while the compression portion 243 of the functional member 24 is in contact with the taper portion 622 of the head 62. Therefore, the portion 243 receives a mechanical pressure or stress in the axial direction from the head 62 so as to compress the portion 243 in the axial direction. In this embodiment, the functional members 24 and 25 are attached to each other at the connection area 26 such that, extension and contraction of each of the functional members 24 and 25 in the axial direction is independent of the other functional member. Therefore, although the portion 243 of the functional member 24 is deformed to be compressed in the axial direction, the sealing functional member 25 is not deformed. That is, the positional relationship between the transmission member 3 and the functional member 25 can be maintained as originally designed. Accordingly, the seal member 5 can be tightly attached to the members 3 and 25 while maintaining the attaching strength.

Further, although the sensor 1 receives the stress from the engine head 2 when being attached to the engine head 62, the sealing functional member 25 of the housing 2 receives no stress from the fixing functional member 24. Therefore, the load detecting unit 4 attached to the functional member 25 and the transmission member 3 receives no load from the functional member 24. Accordingly, unnecessary changes in the output of the sensor 1 can be suppressed, so that the sensor 1 can detect the combustion pressure with high precision. Moreover, it is not required to calibrate the output of the sensor 1 by using another sensor. Accordingly, the sensor 1 used for the engine control can be manufactured at a low cost.

Moreover, even when the fixing functional member 24 is compressed or deformed when being attached to the head 62, the positional relationship between the sealing functional member 25 and the transmission member 3 is maintained. Therefore, the seal member 5 is not moved relative to the sealing functional member 25 or the transmission member 3, so that no stress is applied to the seal member 5. Accordingly, it is not required to considerably heighten the mechanical strength of the seal member 5, the attaching strength of the seal member 5 attached to the functional member 25, the attaching strength of the functional member 5 attached to the transmission member 3. That is, the seal member 5 can be easily attached to the functional member 25 and the transmission member 3 at a low cost.

Furthermore, the clearance 27 is formed between the functional members 24 and 25. Accordingly, the clearance 27 can reliably prevent the functional members 24 and 25 from mechanically interfering with each other. For example, when the functional member 24 receives a compressive force in the axial direction from the head 62, the functional member 24 is sometimes or rarely deformed toward the inner side in the radial direction. In this case, assuming that no clearance is substantially formed between the functional members 24 and 25, the deformed member 24 undesirably pushes the functional member 25. However, in this embodiment, the clearance 27 can prevent the functional members 24 and 25 from mechanically interfering with each other.

Still further, when the sensor 1 is attached to the engine head 62, only the compression portion 243 placed on the distal side of the top end 242 of the portion 241 directly receives the compressive force. However, the functional members 24 and 25 are connected with each other at the connection area 26, and the connection area 26 and the compression portion 243 face each other with the fixing portion 241 between the area 26 and the portion 243. That is, the connection area 26 is placed on the proximal side of the top end 242 of the portion 241. Accordingly, although the compression portion 243 receives the compressive force from the engine head 62, because the fixing portion 241 placed between the connection area 26 and the compression portion 243 is fixed to the engine head 62, no compressive force is transmitted to the functional member 25, the seal member 5 or the transmission member 3.

Especially, in this embodiment, because the connection area 26 is placed at the end of the fixing functional member 24 on the proximal side, any compressive force acting on the functional member 24 is not transmitted to the seal member 5 and the transmission member 3 through the sealing functional member 25. More specifically, when the sensor 1 is attached to the engine head 62, the fixing portion 241 fastened to the engine head 62 is rarely deformed in the axial direction. However, in this embodiment, because the connection area 26 is placed at the end of the functional member 24 on the proximal side, the functional member 25 does not receive adverse influence from the deformation in the fixing portion 241. Accordingly, because the functional member 24 is connected with the functional member 25 at the connection area 26, any compressive force acting on the functional member 24 is not transmitted to the seal member 5 or the transmission member 3 through the functional member 25.

Still further, each of the functional members 24 and 25 of the housing 2 is disposed independent of the other one. Therefore, the clearance 27 can be easily formed between the functional members 24 and 25. Accordingly, the sensor 1 can be easily manufactured.

Still further, the pressure receiving portion 31 of the transmission member 3 has the glow plug therein, and the glow plug heats air accumulated in the chamber 61. Therefore, the portion 31 can has both the combustion pressure receiving function and the function of the grow plug. Accordingly, as compared with both a combustion pressure sensor and a grow plug separately attached to the engine head 62, the sensor 1 with the grow plug can be manufactured at a low cost and can be easily assembled into the engine while occupying a smaller space.

Preferably, the ratio K1/K2 of the spring constant K1 of the sealing functional member 25 to the spring constant K2 of the seal member 5 is set to be equal to or higher than 1 (K1/K2≧1). Therefore, the influence of the displacement of the seal member 5 on the displacement of the seal section can be reduced. Further, the displacement of the seal member 5 can be reduced so as to be smaller than the displacement of the transmission member 3. Accordingly, the sensor 1 can precisely detect the combustion pressure.

More preferably, the ratio K1/K2 is set to be equal to or higher than 1.5 (K1/K2≧1.5). Therefore, the displacement of the seal member 5 can be further reduced so as to be smaller than the displacement of the transmission member 3. Accordingly, the sensor 1 can precisely detect the combustion pressure.

Further, the ratio K3/K4 of the spring constant K3 of the seal section to the spring constant K4 of the transmission member 3 is set to be equal to or higher than 1 (K3/K4≧1). Therefore, the displacement of the seal section can be reliably set to be smaller than the displacement of the transmission member 3. Accordingly, the sensor 1 can precisely detect the combustion pressure.

### Embodiment 2

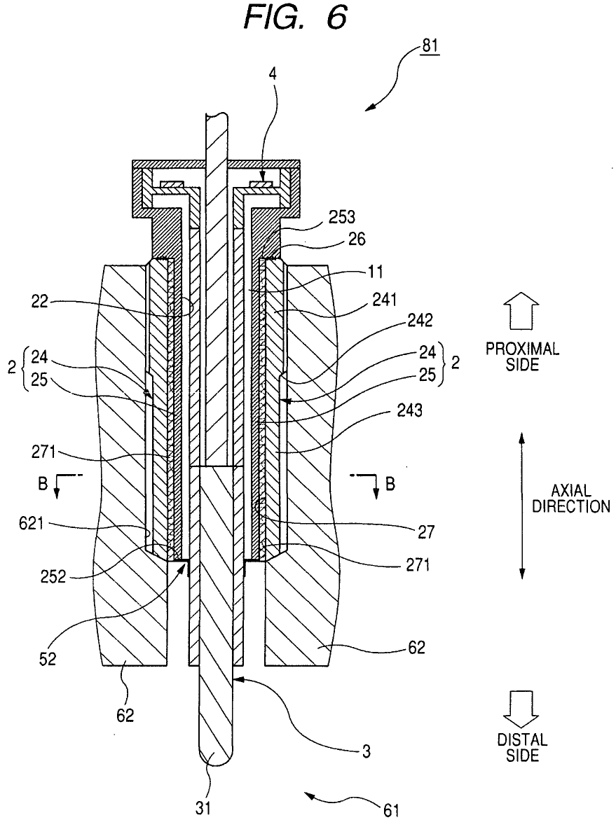

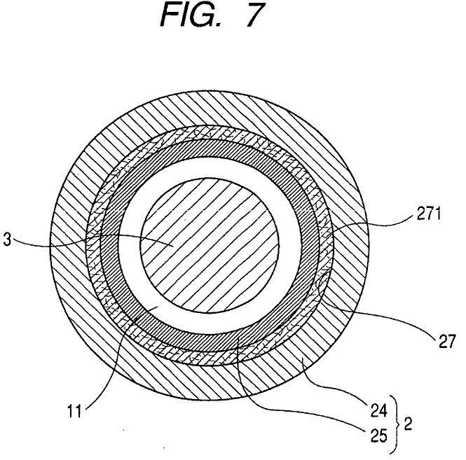

FIG. 5 is a longitudinal sectional view of a combustion pressure sensor according to the second embodiment of the present invention, while FIG. 7 is a sectional view taken substantially along line B-B of FIG. 6.

As shown in FIG. 6 and FIG. 7, a combust ion pressure sensor 81 according to the second embodiment differs from the sensor 1 according to the first embodiment in that the sensor 81 has a packing member 271 packed into the clearance 27. The clearance 27 is packed with carbon graphite, metal mesh made of metal formed in a mesh shape, or the like, so that the packing member 271 is packed into the clearance 27. The packing member 271 is flexibly packed into the clearance 27, so that the compressive force received in the functional member 24 is not transmitted to the functional member 25 through the packing member 271.

With this structure of the sensor 81, the packing member 271 prevents the combustion gas of the chamber 61 from penetrating into the clearance 27. Therefore, the packing member 271 prevents the housing 2 from being heated, by the combustion gas set at a high temperature.

Accordingly, the packing member 271 can prevent the load detecting unit 4 disposed between the housing 2 and the transmission member 3 from receiving a heat load from the combustion gas through the housing 2.

Further, heat of the combustion gas is received in the pressure receiving portion 31 of the transmission member 3, and the heat is dissipated to the engine head 62 through the seal member 5, the sealing functional member 25, the packing member 271 and the fixing functional member 24. In contrast, in the sensor 1 according to the first embodiment, heat transmitted from the sealing functional member 25 to the fixing functional member 24 through the clearance 27 is very small. Therefore, in the second embodiment, a heat dissipation way from the pressure receiving portion 31 to the engine head 62 can be shortened. Accordingly, overheat of the portion 31 can be prevented, and a heat load received in the load detecting unit 4 through the transmission member 3 can be prevented.

Moreover, the packing member 271 can suppress natural vibrations in the transmission member 3 and the functional member 25 disposed inside the functional member 24.

In this embodiment, the whole clearance 27 is packed with the packing member 271. However, the packing member 271 may be disposed only a part of the clearance 27 such as a distal area of the clearance 27.

### Embodiment 3

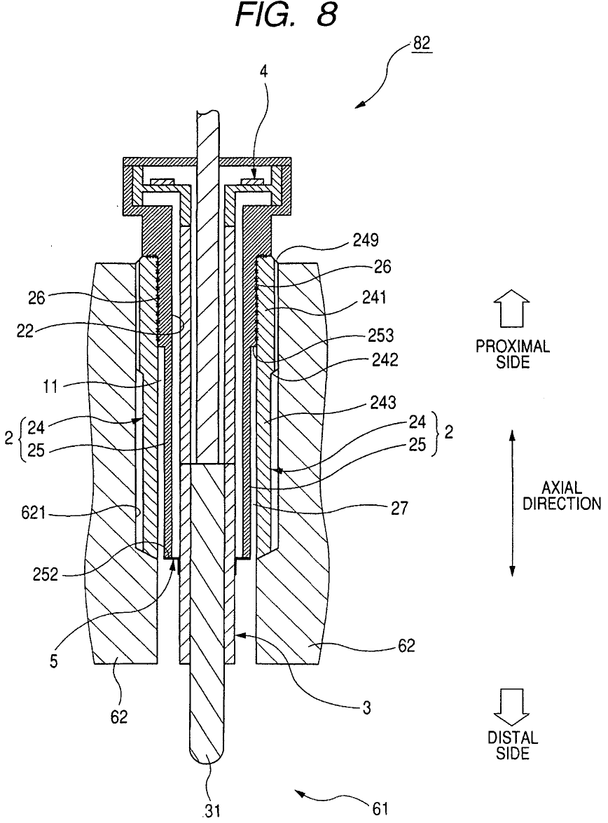

FIG. 8 is a longitudinal sectional view of a combustion pressure sensor according to the third embodiment of the present invention.

As shown in FIG. 8, a combustion pressure sensor 82 according to the third embodiment differs from the sensor 1 according to the first embodiment in that the contact area 26 is placed not only at the end of the fixing functional member 24 disposed on the proximal side but also extends toward the distal side to be placed at the same position as that of the fixing portion 241 in the axial direction. The fixing portion 241 has a proximal end 249 on the proximal side. The end 253 of the sealing functional member 25 facing the clearance 27 is placed between the ends 242 and 249 of the fixing portion 241 in the axial direction. The contact area 26 reaches the end 253 of the functional member 25.

With this structure of the sensor 82, the contact area 26 is placed on the surface of the fixing portion 241 but is not placed on the compression portion 243 disposed on the distal side of the fixing portion 241. The compression portion 243 receives the compressive force directed in the axial direction from the engine head 62. Because the clearance 27 is formed to separate the compression portion 243 from the sealing functional member 25, no compressive force is directly applied from the compression portion 243 to the sealing functional member 25. Further, although the fixing portion 241 fixed to the engine head 52 receives the compressive force from the compression portion 243, because the fixing portion 241 is fixed to the engine head 62, the compressive force is not transmitted to the sealing functional member 25 through the fixing portion 241 and the contact area 26.

The end 253 of the functional member 25 may be placed at the same position as the top end 242 of the fixing portion 241 in the axial direction so as to extend the contact area 26 to the same position as the top end 242 in the axial direction.

Accordingly, even when the contact area 26 extends toward the distal side to be placed on the proximal side of the top end 242 of the fixing portion 241 or to be placed at the same position as the top end 242 in the axial direction, the stress based on the compression and deformation of the fixing functional member 24 is not transmitted to the seal member 5 or the transmission member 3 through the clearance 27 or the fixing portion 241.

Further, because the contact area 26 extends toward the distal side to be placed at the same position as that of the fixing portion 241 in the axial direction, the functional members 24 and 25 can be tightly attached to each other.

In this embodiment, the clearance 27 may be packed with the packing member 271 (see FIG. 6). Because the packing member 271 is flexibly packed into the clearance 27, no compressive force is transmitted to the functional member 25 through the packing member 271.

### Embodiment 4

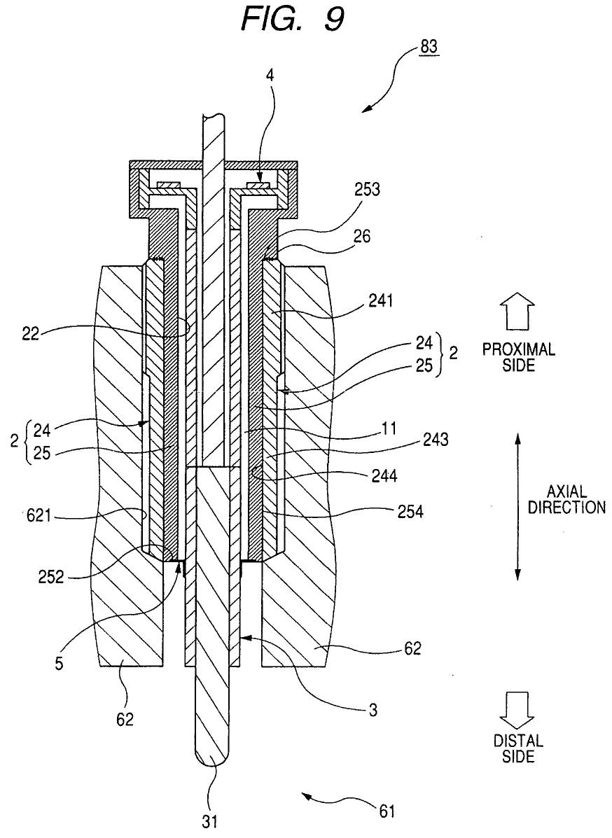

FIG. 9 is a longitudinal sectional view of a combustion pressure sensor according to the fourth embodiment of the present invention.

As shown in FIG. 9, a combustion pressure sensor 83 according to the fourth embodiment differs from the sensor 1 according to the first embodiment in that an outer circumferential surface 254 of the sealing functional member 25 touches or is directly in contact with an inner circumferential surface 244 of the fixing functional member 24. The surfaces 244 and 254 of the functional members 24 and 25 are not bonded together, or each of the functional members 24 and 25 is extensible and contractible in the axial direction regardless of extension or contraction of the other one in the axial direction. The members 24 and 25 are bonded together only at the contact area 26.

With this structure of the sensor 83, no combustion gas penetrates into a space between the functional members 24 and 25. Therefore, the direct contact between the functional members 24 and 25 substantially prevents heat of the combustion gas from being transmitted to the load detecting unit 4 through the housing 2, so that the load detecting unit 4 hardly receives the heat load based on the heat of the combustion gas.

Accordingly, the heat load applied to the unit 4 can be considerably reduced, and the sensor 83 can be further superior in durability and can detect the combustion pressure with higher precision.

Further, it is not required to provide a clearance between the functional members 24 and 25 with a packing member, so that the sensor 83 can be manufactured at a low cost.

Moreover, the direct contact between the functional members 24 and 25 shortens the heat dissipating way from the pressure receiving portion 31 to the engine head 62. Accordingly, the heat received in the pressure receiving portion 31 can be efficiently dissipated to the engine head 62, so that the heat load applied to the unit 4 can be further reduced.

### Embodiment 5

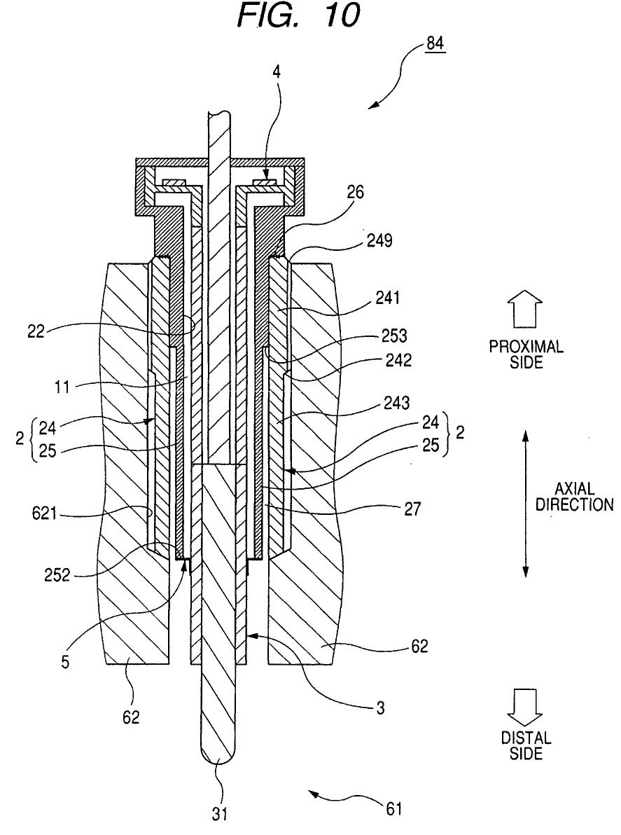

FIG. 10 is a longitudinal sectional view of a combustion pressure sensor according to the fifth embodiment of the present invention.

As shown in FIG. 10, a combustion pressure sensor 84 according to the fifth embodiment differs from the sensor 1 according to the first embodiment in that the end 253 of the sealing functional member 25 facing the clearance 27 is placed on the proximal side of the top end 242 of the fixing portion 241 and is placed on the distal side of the proximal end 249 of the fixing portion 241. The surfaces 244 and 254 of the functional members 24 and 25 touch or are directly in contact with each other on the proximal side of the end 253 of the functional member 25 without being bonded with each other. Therefore, the clearance 27 communicating with the chamber 61 reaches a position which is placed on the proximal side of the top end 242 of the fixing portion 241 and the distal side of the proximal end 249 of the fixing portion 241. The contact area 26 is placed only on the proximal end of the functional member 24.

With this structure of the sensor 84, because the clearance 27 extends toward the proximal side of the top end 242 of the fixing portion 241, the clearance 27 exists on the inner side of the compression portion 243 in the radial direction.

Accordingly, even when the compression portion 243 receiving the compressive force from the engine head 62 is deformed or bent toward the inner, side, the clearance 27 can prevent the functional members 24 and 25 from mechanically interfering with each other.

Further, as compared with the sensor 1 (see FIG. 3), the clearance 27 is disposed to be further away from the load detecting unit 4. Accordingly, the heat of the combustion gas transmitted to the unit 4 through the sealing functional member 25 can be considerably reduced, so that the heat load applied to the unit 4 can be further reduced.

Moreover, the heat received in the pressure receiving portion 31 of the transmission member 3 is transmitted to the engine head 62 through the functional members 24 and 25 being directly in contact with each other. Therefore, the heat received in the portion 31 can be efficiently dissipated to the engine head 62.

Furthermore, the volume of the clearance 27 is smaller than that according to the first embodiment. Accordingly, when a packing member is packed into the clearance 27, the volume of the packing member can be reduced.

In the first to fifth embodiments, the functional members 24 and 25 are separately formed. However, the functional members 24 and 25 may be integrally formed with each other.

These embodiments should not be construed as limiting the present invention to structures of those embodiments, and the structure of this invention may be combined with that based on the prior art.

What is claimed is:

1. A combustion pressure sensor, comprising:
a housing substantially having a cylindrical shape, the housing having a fixing functional member and a sealing functional member disposed on an inner side of the fixing functional member in a radial direction of the sensor, the fixing functional member having a fixing portion fixed to an internal combustion engine, the fixing functional member and the sealing functional member being connected with each other at a connection area such that extension and contraction of the sealing functional member in an axial direction of the sensor is independent of the fixing functional member;
a transmission member disposed on the inner side of the sealing functional member of the housing so as to face the sealing functional member through an opening and to be exposed to a combustion gas of a combustion chamber on a first side in the axial direction, the transmission member being movable along the axial direction in response to a combustion pressure of the combustion gas;
a detecting unit, disposed between the sealing functional member of the housing and the transmission member on a second side in the axial direction opposite to the first side so as to face the opening, which detects the combustion pressure in response to the movement of the transmission member; and
a seal member, attached to the sealing functional member of the housing and the transmission member on the first side so as to shield the opening from the combustion chamber.

2. The sensor according to claim 1, wherein the sealing functional member faces the fixing functional member through a clearance.

3. The sensor according to claim 2, wherein the clearance faces the combustion chamber, and a packing member is disposed in the clearance.

4. The sensor according to claim 1, wherein the fixing functional member has a stress receiving portion extending from an end of the fixing portion toward the first side to receive stress from the engine, and the connection area is placed at the same position in the axial direction as the end of the fixing portion or is placed on the second side of the end of the fixing portion.

5. The sensor according to claim 1, wherein the fixing functional member has a stress receiving portion extending from the fixing portion toward the first side, and the connection area is placed at an end of the fixing functional member on the second side.

6. The sensor according to claim 1, wherein the fixing functional member and the sealing functional member are disposed independently of each other, and the fixing functional member and the sealing functional member are connected to each other at the connection area.

7. The sensor according to claim 1, wherein the sealing functional member faces the fixing functional member through a clearance, and the clearance extends between both ends of the fixing functional member on the first and second sides.

8. The sensor according to claim 1, wherein the sealing functional member faces the fixing functional member through a clearance, and a width of the clearance in the radial direction is smaller than a width of the opening.

9. The sensor according to claim 1, wherein an outer circumferential surface of the sealing functional member touches or is directly in contact with an inner circumferential surface of the fixing functional member without any clearance.

10. The sensor according to claim 1, wherein the transmission member has a pressure receiving portion protruded into the combustion chamber to receive the combustion pressure, a glow plug is disposed into the pressure receiving portion, and the glow plug has a heating member and a conducting member through which electric power is supplied to the heating member to heat the heating member.

11. The sensor according to claim 1, wherein the sealing functional member is deformed in the axial direction at a first spring constant, the seal member is deformed in the axial direction at a second spring constant, and a ratio of the first spring constant to the second spring constant is equal to or larger than 1.

12. The sensor according to claim 11, wherein the ratio is equal to or larger than 1.5.

13. The sensor according to claim 1, wherein a seal section composed of the seal member and the sealing functional member aligned along the axial direction is deformed in the axial direction at a first spring constant, the transmission member is deformed in the axial direction at a second spring constant, and a ratio of the first spring constant to the second spring constant is equal to or larger than 1.
